(19) United States
(12) Patent Application Publication
(10) Pub. No.: US 2007/0068584 A1
(43) Pub. Date: Mar. 29, 2007

(54) Y-manifold valve

(76) Inventors: Douglas J. Murdock, Hendersonville, TN (US); Jeremiah Davis, Lebanon, TN (US)

Correspondence Address: HARNESS, DICKEY & PIERCE, P.L.C., P.O. BOX 828, BLOOMFIELD HILLS, MI, 48303, US

(21) Appl. No.: 11/523,204

(22) Filed: Sep. 19, 2006

Related U.S. Application Data
(60) Provisional application No. 60/721,137, filed on Sep. 27, 2005.

(51) Int. Cl. F16K 11/085

(52) U.S. Cl. 137/625.47

(57) ABSTRACT

A valve includes a one piece, Y-shaped body including a main member, a first branch having a first branch flow passage and a second branch having a second branch flow passage. The first and second branches extend outwardly from the main member. A single ball is rotatably disposed within the body. The ball includes a common flow port alignable with the first flow passage in a first rotated position and with the second flow passage in a second rotated position. A ball first flow port open to the common flow port is alignable with the main member in the first rotated position. A ball second flow port open to the common flow port is alignable with the main member in the second rotated position. First and second branch longitudinal centerlines define an included angle less than 90 degrees.

### CROSS-REFERENCE TO RELATED APPLICATIONS

This application claims the benefit of U.S. Provisional Application No. 60/721,137, filed on Sep. 27, 2005. The disclosure of the above application is incorporated herein by reference.

### FIELD

The present disclosure relates in general to valves and more specifically to multiple inlet and/or outlet manifold valves.

### BACKGROUND

The statements in this section merely provide background information related to the present disclosure and may not constitute prior art.

Three way valves are known which provide the capability to direct an inlet source of fluid to one of two outlet ports of the valve. Three way ball valves are also known which provide a rotatable ball having internal passages alignable between an inlet of the valve and either of the two outlet ports. Known three way valves have several drawbacks including orienting each outlet port at a right angle to the inlet. This induces greater pressure drop through the valve because the fluid must turn abruptly before discharge from the valve. This configuration also increases at least a width of the space envelope required to mount not only the valve, but the immediately connected piping or fittings. This configuration therefore acts as a limitation for a center-to-center spacing between valves if configured in a side-by-side or “manifold” type arrangement.

Common three way ball valves also require multiple internal components to support the seals required to rotatably support the ball. These additional components add cost and weight to the valve as well as complexity and potentially increased maintenance.

### SUMMARY

According to at least one embodiment, a valve includes a one piece, substantially Y-shaped body including a main member, a first branch, and a second branch. The first and second branches extend outwardly from the main member. A single ball is rotatably disposed within the body. The ball includes a plurality of flow ports operable to provide fluid communication between the main member and a selectable one of the first and second branches. A longitudinal centerline of each of the first and second branches defines an included angle less than 90 degrees.

According to other embodiments, a valve includes a one piece, Y-shaped body including a main member, a first branch having a first branch flow passage and a second branch having a second branch flow passage. The first and second branches extend outwardly from the main member. A single ball is rotatably disposed within the body. The ball includes a common flow port alignable with the first flow passage in a first rotated position and with the second flow passage in a second rotated position. A ball first flow port open to the common flow port is alignable with the main member in the first rotated position. A ball second flow port open to the common flow port is alignable with the main member in the second rotated position. First and second branch longitudinal centerlines define an included angle less than 90 degrees.

According to still other embodiments a method for constructing a valve is provided.

A Y-manifold valve of the present disclosure offers several advantages. By orienting the outlet branches such that their centerlines define an included angle of less than 90 degrees, a valve pressure drop is reduced compared to common three way valve designs because flow through the valve is more direct. The space envelope of the valve of the present disclosure is also smaller than conventional three way valves, and particularly when fittings or pipe are added to the connections. This allows multiple valves to be more tightly arranged. Two of the ball seals of the present valve are held by cavities in the body, eliminating the need for additional parts to hold and/or align these seals. A common outlet port is provided with the ball which is alignable with either valve branch outlet port. A valve of the present disclosure can also be optimized by reducing the included angle while increasing the valve size, or increasing the included angle and decreasing the valve body size. This permits further optimization of the valve's pressure drop for different valve/connection sizes. The present valve design is also easily forged, providing a less porous valve body for particular fluid applications such as refrigerant use.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a Y-manifold valve of the present disclosure;

FIG. 2 is a perspective partially cutaway view similar to FIG. 1 showing internal components and flow passages of the valve of FIG. 1;

FIG. 3 is a top plan view similar to FIG. 2 further showing an inlet tailpiece;

FIG. 4 is a side elevational view of the valve of FIG. 3;

FIG. 5 is a cross sectional side elevational view taken at Section 5-5 of FIG. 3;

FIG. 6 is a cross sectional plan view taken at Section 6-6 of FIG. 4; and

FIG. 7 is an exploded assembly view of the Y-manifold valve of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

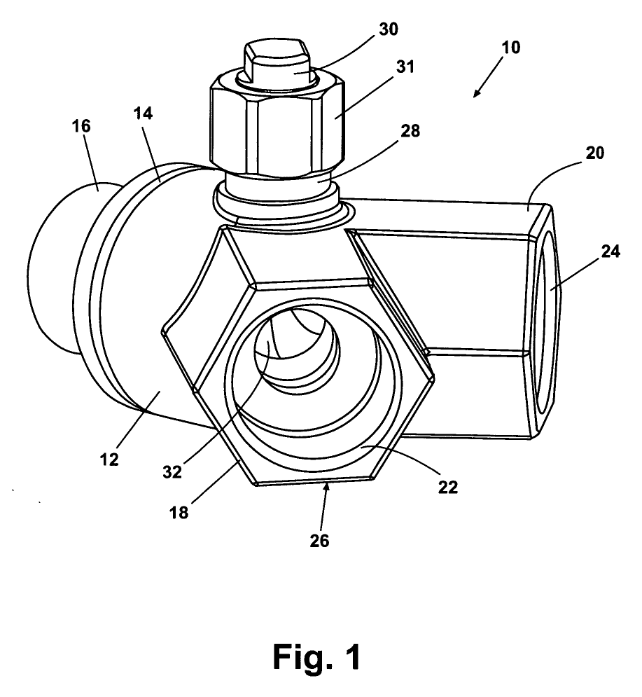

According to several embodiments of the present disclosure and referring generally to FIG. 1, a Y-manifold valve 10 includes a body 12. Body 12 further includes a main member 14 and first and second branches 18, 20. A tail piece 16 is fastenably secured to main member 14. Main member 14 and first and second branches 18, 20 are all integrally joined and in at least several embodiments of the present disclosure are created together as a forging, a casting, or sections welded or brazed together.

First branch 18 includes a first branch passage 22. Second branch 20 includes a second branch passage 24. Each of the first and second branches 18, 20 in some embodiments include a plurality of branch outer faces 26 which in the embodiment shown define a six-sided polygon. Branch outer face 26 can also be provided in a plurality of geometric designs, including but not limited to circles, ovals, squares or other polygonal shapes. A stem boss 28 is integrally connected to body 12 and in some embodiments is created for example by forging along with main member 14, first branch 18, and second branch 20. Stem boss 28 provides for rotational actuation of internal members of Y-manifold valve 10 using for example an actuator adaptor 30 retained by a retainer element 31. Actuator adaptor 30 is rotated to impart rotation to a ball 32 rotatably disposed within body 12.

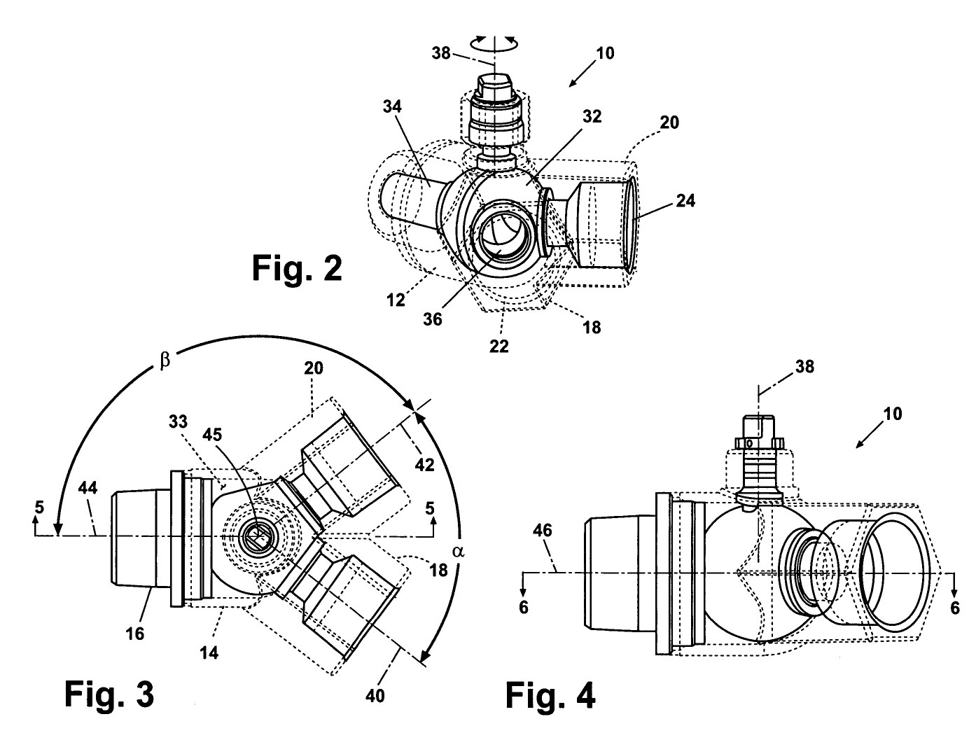

As best seen in reference to FIG. 2, ball 32 is rotatably disposed within a cavity 33 of body 12. When received in main member 14, tail piece 16 further defines a main flow passage 34 providing fluid communication to ball 32, thereby creating a ball flow passage 36. Ball 32 is rotatable about a stem longitudinal axis 38.

Referring now to FIG. 3, a first branch longitudinal centerline 40 of first branch 18 and a second branch longitudinal centerline 42 of second branch 20 together define an included angle α which is less than 90°. Branch included angle α can vary depending upon parameters such as valve size, flow passage required size, and/or pipe fitting sizes for attachment to Y-manifold valve 10. For example, Y-manifold valve 10 can be optimized for branch included angle α by increasing a total body size and decreasing angle α. Alternately, branch included angle a between first and second branch passages 22, 24 can be increased while simultaneously decreasing the size of Y-manifold valve 10. A main member longitudinal centerline 44 of main member 14 is oriented at a flow diversion angle β with respect to either first branch 18 or second branch 20. In some embodiments, flow diversion angle β is greater than 90° and defines a complementary angle to half of the branch included angle α. In other embodiments, the sum of flow diversion angle β (being greater than 90°) plus half of included angle α equals an angle greater than 180 degrees for one of the first and second branch passages 22, 24. A junction point 45 is defined at an intersection between first and second branch longitudinal centerlines 40, 42 and main member longitudinal centerline 44. In some embodiments, stem longitudinal axis 38 is positioned coincident with junction point 45.

Referring generally now to FIGS. 3 and 4, each of first and second branch longitudinal centerlines 40, 42 and main member longitudinal centerline 44 in some preferred embodiments are coplanar with a body central plane 46. Y-manifold valve 10 is not limited to this configuration of flow passages being coplanar with body central plane 46. Any one of main member 14, and/or first or second branches 18, 20 can also be disposed at an angle relative to body central plane 46. For simplicity of construction and operation of ball 32, stem longitudinal axis 38 is positioned substantially 90° from body central plane 46, however this configuration can also be modified at the discretion of the designer, for example by disposing longitudinal axis 38 at an angle other than 90° from body central plane 46.

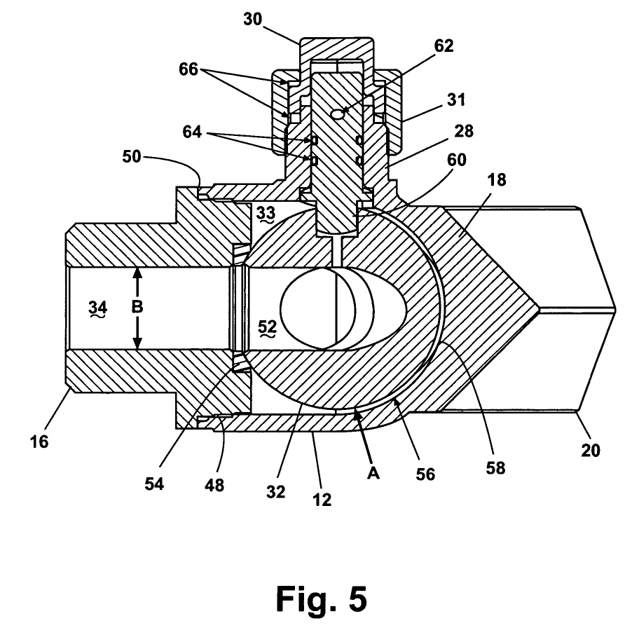

As best seen in reference to FIG. 5, tail piece 16 is coupled to main member 14 using a fastening feature 48. In several embodiments, fastening feature 48 includes a plurality of female threads, such as machine (MS) threads. A seal joint 50 is created at a junction between tail piece 16 and main member 14. In some embodiments, seal joint 50 is a weld joint, but can also include gaskets or other sealing material. In a first rotated position, first flow port 52 of ball 32 is aligned with main flow passage 34. A first ball seal 54 is disposed between ball 32 and tail piece 16 to provide a fluid seal between first flow port 52 and main flow passage 34, while simultaneously allowing rotation of ball 32. Ball 32 is further rotatably received within a curved body portion 56 of body 12. Curved body portion 56 is contoured to substantially follow a ball diameter “A” of ball 32. Second ball seal 58 is partially shown at a junction between ball 32 and first branch 18.

A stem 60 is rotatably received in stem boss 28 and linked with ball 32 to provide the rotational driving force for rotation of ball 32. A pin receiving aperture 62 is provided in stem 60 to lock stem 60 and retainer element 31 together for co-rotation. A plurality of O-ring seals 64 is disposed about stem 60 to provide a fluid seal between stem 60 and an internal cavity of stem boss 28. A plurality of gaskets 66 are also included to provide a seal between retainer element 31 and stem boss 28 while allowing rotation of retainer element 31. Main flow passage 34 created as a through aperture in tail piece 16 includes a passage diameter “B”.

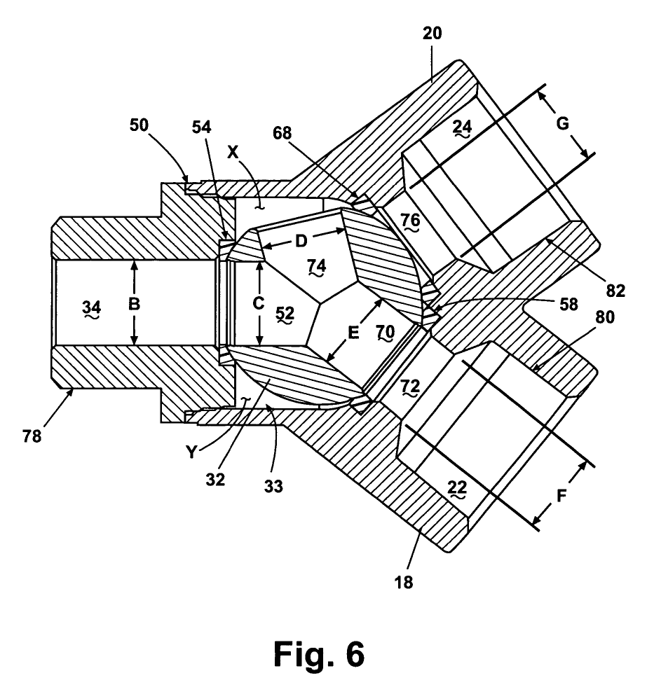

Referring now generally to FIG. 6, a third ball seal 68 is disposed between ball 32 and second branch 20, similar to second ball seal 58 previously discussed. The first rotated position of ball 32 is shown in FIG. 6. In the first rotated position, a common port 70 of ball 32 is coaxially aligned with a first branch port 72 which openly communicates with first branch passage 22 of first branch 18. Also in the first rotated position, a second flow port 74 of ball 32 is isolated from a second branch port 76, which communicates with second branch passage 24 of second branch 20. In the first rotated position of ball 32, second flow port 74 opens into cavity 33 of body 12 into a first cavity portion “X”.

In the first rotated position a flow path is open which includes main flow passage 34, first flow port 52, common port 70, first branch port 72, and first branch passage 22. A second rotated position of ball 32 (not shown) is created by rotating ball 32 counterclockwise from the position shown in FIG. 6 until second flow port 74 of ball 32 aligns with main flow passage 34 and common port 70 aligns with second branch port 76. In the second rotated position of ball 32 a flow passage therefore includes main flow passage 34, second flow port 74, common port 70, second branch port 76, and second branch passage 24. In the second rotated position of ball 32, first flow port 52 of ball 32 is directed towards a second cavity portion “Y” of cavity 33. Common port 70 of ball 32 therefore is in fluid communication with either first branch port 72 or second branch port 76 for any flow condition of Y-manifold valve 10.

In some embodiments of the present disclosure, passage diameter “B” of main flow passage 34 is substantially equal to a port diameter “C” first flow port 52, a port diameter “D” of second flow port 74, a port diameter “E” of common port 70, a branch port diameter “F” of first branch port 72, and a branch port diameter “G” of second branch port 76. Although various ones of the port diameters “B” through “G” can be varied from any one of the other port diameters, overall flow resistance through Y-manifold valve 10 is maintained or reduced through the use of substantially equal flow port diameters.

As further shown in reference to FIG. 6, a first fastening feature 78 is provided with tail piece 16. First fastening feature 78 in some embodiments includes a male NPT thread for threadably fastening Y-manifold

valve 10. Alternate fastening features can also be provided for tail piece 16, such as male MS threads, brazed joints, socket welded joints, butt welded joints, or flanges at the discretion of the designer. Similarly, in some embodiments both first and second branches 18, 20 provide fastening features 80, 82 respectively. In some embodiments, fastening features 80, 82 include female NPT threads. In other embodiments, fastening features 80, 82 can also be adapted as previously described in reference to first fastening feature 78.

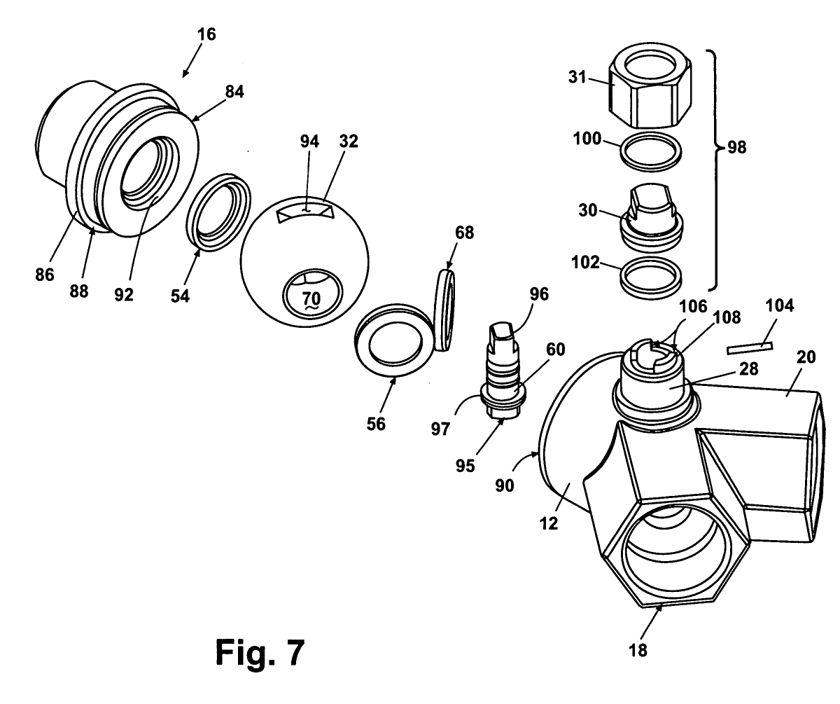

Referring now to FIG. 7, a mating fastening feature 84 is provided with tail piece 16, such as a plurality of male MS threads sized for engaging to the exemplary female MS threads of fastening feature 48. Tail piece 16 in some embodiments further includes a radial flange 86, a flange face 88, and a cavity 92. Flange face 88 is adapted to abut with a body end face 90 of main member 14. Cavity 92 is adapted to receive first ball seal 54. Ball 32 further includes a slot 94 adapted to receive a ball engagement end 95 of stem 60. A similar engagement end 96 of stem 60 is received within actuator adaptor 30. According to some embodiments of the present disclosure, a radial flange 97 is provided with stem 60 which abuts internal structure of body 12 to prevent high pressure conditions within body 12 from ejecting stem 60. When radial flange 97 is used, stem 60 is mounted in the body 12 by insertion through cavity 33 and then passed upwards as viewed in FIG. 7 through stem boss 28.

A seal cap assembly 98 includes each of actuator adaptor 30 and retainer element 31 separated by a gasket 100. A second gasket 102 is also provided at the connection between actuator adaptor 30 and stem boss 28. A pin 104 is slidably inserted through pin receiving aperture 62 (shown and described in reference to FIG. 5) to releasably retain the connection between seal cap assembly 98 and stem 60. Opposed engagement surfaces 106 created in extended sleeve 108 define angular rotation limits of ball 32. The angular spacing between engagement surfaces 106 is therefore predetermined for individual embodiments of Y-manifold valve 10 to correspond to branch included angle α.

Materials for Y-manifold valve 10 in some embodiments include brass for body 12, ball 32, and tail piece 16. Other metals including but not limited to aluminum, steel, stainless steel, and/or polymeric materials can also be used in these applications. First, second, and third ball seals 54, 58, 68 in some embodiments are provided of a polymeric material such as PTFE or polyamide material. These exemplary polymeric materials can also be replaced by other gasket materials commonly available for these applications depending on the type of fluid in the application. Ball 32 can also be provided with a plating material such as chrome to reduce rotational friction against the ball seals. As previously noted herein, body 12 can be created from a forging process, a casting process, a welding process, a machining process, a molding, or other processes known for preparation of valve bodies. The disclosure is therefore not limited to the types of material selected or the process used in preparing Y-manifold valve 10.

Y-manifold valve of the present disclosure offers several advantages. By orienting the outlet branches such that their centerlines define an included angle of less than 90 degrees, a valve pressure drop is reduced compared to common three way valve designs because flow through the valve is more direct. The space envelope of the valve of the present disclosure is also smaller than conventional three way valves, and particularly when fittings or pipe are added to the connections. This allows multiple valves to be more tightly arranged. Two of the ball seals of the present valve are held by cavities in the body, eliminating the need for additional parts to hold and/or align these seals. A common outlet port is provided with the ball which is alignable with either valve branch outlet port. The overall flow characteristics including an overall pressure drop of a valve of the present disclosure can also be optimized by reducing the included angle α while reducing one or more of the valve port sizes thus reducing the valve body size, or increasing the included angle α and increasing one or more of the valve port sizes thus increasing the valve body size. For example only, included angle α can be reduced from 85° to 80°, which tends to decrease flow pressure drop, allowing a decrease of one or all of passage diameter “B”, port diameter “E” and/or port diameter “G”. This permits optimization of the valve's pressure drop for different valve/connection sizes. The present valve body can also be forged, providing a less porous valve body for particular fluid applications such as refrigerant use.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A valve, comprising:
a one piece, substantially Y-shaped body including a main member, a first branch, and a second branch, the first and second branches extending outwardly from the main member;
a single ball rotatably disposed within the body, the ball including a plurality of flow ports operable to provide fluid communication between the main member and a selectable one of the first and second branches;
wherein a longitudinal centerline of each of the first and second branches define an included angle less than 90 degrees.

2. The valve of claim 1, further comprising a tailpiece fixedly connectable to the main member, the tailpiece including a valve main flow passage.

3. The valve of claim 2, further comprising:
a first branch flow passage created through the first branch; and
a second branch flow passage created through the second branch.

4. The valve of claim 3, wherein the ball further comprises a common flow port alignable with the first branch flow passage by rotation of the ball to a first position, the common flow port alignable with the second branch flow passage by rotation of the ball to a second position.

5. The valve of claim 4, wherein the ball further comprises:
a first flow port open to the common flow port, the first flow port alignable with the main flow passage when the ball is in the first position; and
a second flow port open to the common flow port, the second flow port alignable with the main flow passage when the ball is in the second position.

6. The valve of claim 3, further comprising a thread created in each of the first and second flow passages.

7. The valve of claim 1, further comprising a stem boss integrally joined to the body, the stem boss including a through aperture.

8. The valve of claim 7, further comprising a stem operable to rotate the ball, the stem insertable through the body and rotatably disposed through the through aperture of the stem boss.

9. The valve of claim 1, further comprising a longitudinal axis of the main member defining an angle greater than 90 degrees with any one of the longitudinal centerlines of the first and second branches.

10. The valve of claim 1, wherein the ball is contained entirely within an envelope defined by the main member and the first and second branches, and a rotational axis of the ball is aligned with an axis defining a common junction of the main member with the first and second branches.

11. A valve, comprising:
a one piece, substantially Y-shaped body including a main member, a first branch having a first branch flow passage, and a second branch having a second branch flow passage, the first and second branches extending outwardly from the main member;
a single ball rotatably disposed within the body, the ball including:
a common flow port alignable with the first branch flow passage in a first rotated position and alignable with the second branch flow passage in a second rotated position;
a first flow port open to the common flow port and alignable with the main member in the first rotated position; and
a second flow port open to the common flow port and alignable with the main member in the second rotated position;
wherein a longitudinal centerline of each of the first and second branches define an included angle less than 90 degrees.

12. The valve of claim 11, further comprising a tailpiece fixedly connectable to the main member, the tailpiece including a valve main flow passage sized substantially equal to a port diameter of the first and second flow ports and alignable with one of the first and second flow ports when the ball is rotated to one the first and second rotated positions.

13. The valve of claim 12, further comprising:
a female thread disposed in the first and second branches; and
a male thread disposed on an external surface of the tailpiece.

14. The valve of claim 11, further comprising:
a stem boss integrally connected to the body; and
a stem rotatably disposed in the stem boss and operable to rotate the ball between the first and second rotation positions.

15. The valve of claim 14, wherein the body further comprises a single forging including each of the main member, the first branch, the second branch and the stem boss.

16. The valve of claim 11, wherein the body further comprises a single casting including each of the main member, the first branch, and the second branch.

17. The valve of claim 11, further comprising:
an internal cavity of the body containing the ball;
wherein in the first rotated position of the ball the second flow port is open to a first portion of the internal cavity; and
wherein in the second rotated position of the ball the first flow port is open to a second portion of the internal cavity.

18. A method for constructing a valve, the valve including a substantially Y-shaped body having a main member and first and second branches, the first branch including a first branch flow passage and the second branch including a second branch flow port, a single ball having a common flow port and first and second flow ports open to the common flow port, and a tailpiece defining a main flow port, the method including:
restricting rotation of the ball between a first and a second rotated position; and
configuring the common flow port to be operably alignable with the first branch flow passage in the first rotated position and to operably align with the second branch flow passage in the second rotated position.

19. The method of claim 18, further comprising engaging the tailpiece with the main member to operably align the main flow port with the ball.

20. The method of claim 19, further comprising:
disposing the ball within the body through the main member; and
inserting at least one seal in contact with both the ball and the body to rotatably position the ball prior to the engaging step.

21. The method of claim 18, further comprising angularly extending the first and second branches from the main member such that a longitudinal centerline of each of the first and second branches define an included angle less than 90 degrees.

22. The method of claim 18, further comprising forging the body.

23. The method of claim 18, further comprising creating the body from one of a metal material and a polymeric material.

24. The method of claim 18, further comprising casting the body.

25. The method of claim 18, further comprising optimizing the body by one of:
performing a first optimization including:
increasing a flow port size; and
increasing the included angle; and
performing a second optimization including:
decreasing the flow port size; and
decreasing the included angle.

26. The method of claim 18, further comprising concurrently forging both the body and a stem boss.

27. The method of claim 18, further comprising:
inserting a stem through the main member; and
rotatably mounting the stem in a stem boss.

28. The method of claim 18, further comprising:
orienting the first flow port to be operably alignable with the main flow port in the first rotated position; and
orienting the second flow port to be operably alignable with the main flow port in the second rotated position.
